(19) United States
(12) Patent Application Publication
(10) Pub. No.: US 2026/0091866 A1
(43) Pub. Date: Apr. 2, 2026

(54) THERMAL PROTECTION DEVICE FOR A LOWER LONGITUDINAL MEMBER OF AN AIRCRAFT BOX STRUCTURE

(71) Applicant: Airbus Operations SAS, TOULOUSE (FR)

(72) Inventors: Jonathan BLANC, TOULOUSE (FR); Jacky PUECH, TOULOUSE (FR); Solène CRUAUD PRIEUR, TOULOUSE (FR); Fabien POUSSOU, TOULOUSE (FR); Jérôme NENY, TOULOUSE (FR)

(21) Appl. No.: 19/341,219

(22) Filed: Sep. 26, 2025

(30) Foreign Application Priority Data
Sep. 30, 2024 (FR) FR2410439

(51) Int. Cl. B64C 1/40; B64D 27/16

(52) U.S. Cl. CPC B64C 1/403; B64D 27/16

(57) ABSTRACT

A thermal protection device for a lower longitudinal member of an aircraft box structure. The device incudes a shield which includes a first panel extending parallel and at a first distance from the lower longitudinal member, a second panel arranged between the first panel and the lower longitudinal member and which extends parallel and at a second distance from the lower longitudinal member. The panels delimit, relative to one another, a channel extending parallel to and at a distance from the lower longitudinal member. A front end of the channel forms an inlet orifice of an airflow originating from the fan of the aircraft and flowing from the front to the rear of the aircraft through the channel. A rigid thermal protection of the lower longitudinal member is provided by causing an airflow originating from the fan to flow inside the shield.

### CROSS-REFERENCES TO RELATED APPLICATIONS

This application claims the benefit of the French Patent Application No. FR2410439 filed on Sep. 30, 2024, the entire disclosures of which are incorporated herein by way of reference.

### FIELD OF THE INVENTION

The present invention relates to a thermal protection device for a lower longitudinal member of an aircraft box structure, and a propulsion system and an aircraft comprising such a protection device.

### BACKGROUND OF THE INVENTION

Conventionally, and as illustrated in FIGS. 1 and 2, an aircraft 50 comprises a fuselage 51 and a wing 52 on each side of the fuselage 51. At least one propulsion system 100 is fixed below each wing 52 and comprises a turbojet 102 and an engine pylon 104.

Conventionally, X denotes the longitudinal axis of the propulsion system 100 corresponding to a longitudinal axis X of the turbojet 102. Moreover, Y denotes the transverse axis of the system 100 corresponding to a transverse axis of the turbojet 102, this axis being horizontal when the aircraft is on the ground, and Z denotes the vertical axis or the vertical height of the propulsion system 100 corresponding to a vertical axis of the turbojet 102, this axis being vertical when the aircraft is on the ground, these three axes X, Y and Z being mutually at right-angles.

Moreover, the terms “front” and “rear” are to be considered relative to a direction of displacement to the front of the aircraft when the turbojet 102 is in operation, this direction being illustrated by the arrow 107. The turbojet 102 also has a vertical median plane P XZ passing through the longitudinal axis X and the vertical axis Z.

The turbojet 102 comprises, at the front, a fan housing 102a surrounding a tubular fan duct in which a fan rotates and, at the rear of the fan housing 102a, a central housing 102b of smaller size enclosing the core of the turbojet 102. The fan housing 102a and the central housing 102b generally extend coaxially about the longitudinal axis X.

FIG. 2 shows a propulsion system 100 with the turbojet 102 and the engine pylon 104 by which the turbojet 102 is fixed to the wing 52. The engine pylon 104 is represented here by its primary structure 106 which is fixed below the wing 52.

The primary structure 106 extends along the longitudinal axis X between a front end and a rear end, and takes the form of a box structure which comprises a lower longitudinal member 106a, an upper longitudinal member 106b, two lateral panels (not illustrated) connecting the two longitudinal members and internal ribs 106c distributed along the box structure 106.

The turbojet 102 is fixed below the engine pylon 104 by means of engine mountings which conventionally comprise, at the front, a front engine mount 107a, at the rear, a rear engine mount 107b and, between the front and rear engine mounts, an assembly for absorbing thrust force comprising force-absorbing connecting rods 107c fixed between the turbojet 102 and the box structure 106 in order to absorb the thrust forces generated by the turbojet 102.

The engine pylon also comprises a secondary structure 108 which is arranged in the region of the front end of the box structure 106 and below the lower longitudinal member 106a. This secondary structure is located directly opposite the fan housing 102a and thus receives external air from the turbojet 102. The secondary structure 108 is thus not exposed to very high temperature levels since the external air is generally cold and cools in the secondary structure 108.

This is not the case of the lower longitudinal member 106a of the box structure 106. More specifically, and as illustrated in hatched lines in FIG. 2, the zone 110 located between the lower longitudinal member 106a, the secondary structure 108 and the central housing 102b of the turbojet is exposed to very high temperatures and this zone thus constitutes a zone at significant risk of fire.

In order to thermally protect the box structure 106 of the engine pylon 104, it is known to use a thermal cover below the lower longitudinal member 106a. Such a thermal cover is generally flexible and is placed against the lower longitudinal member 106a, extending from the secondary structure 108 to the rear end of the lower longitudinal member 106a.

FIG. 3 illustrates an example of a fixing point of a thermal cover 109 on the lower longitudinal member 106a according to the prior art. Generally, the thermal cover 109 comprises an insulating plate 109a comprising a body, for example produced from mineral silica powder, clamped between two thin metal sheets, for example of 0.2 mm thickness and produced from Inconel (Registered Trademark). The plate 109a is fixed to the lower face of the lower longitudinal member 106a via a spacer 109b which is fixed, on the one hand, to the lower longitudinal member 106a by two bolts 109c and, on the other hand, to the insulating plate 109a by a bolt 109d.

A drawback with this solution is that each fixing point of the thermal cover 109 constitutes a significant thermal bridge. More specifically, at each fixing point, the cover 109 is non-existent (or quasi non-existent) which can cause a significant localized increase in the temperature of the lower longitudinal member 106a. Moreover, the cover 109 generally has a thickness of greater than 20 mm which represents a relatively high space requirement, limiting the possibilities of installing other equipment in this zone 110. Moreover, the materials used for producing such a thermal cover are relatively expensive. Finally, since such a thermal cover is relatively fragile, the thermal cover can be easily damaged during the handling thereof, the installation thereof or the installation of adjacent equipment.

Thus, there is a need to provide an optimal thermal protection of the lower longitudinal member of an engine pylon box structure for an aircraft which remedies at least some of these drawbacks.

### SUMMARY OF THE INVENTION

A subject of the present invention is to propose a device designed for the thermal protection of a lower longitudinal member of an aircraft box structure which ensures an optimal thermal protection while limiting the thermal bridges, which is simple to implement and which is robust, in particular.

To this end, the invention proposes a device designed for the thermal protection of a lower longitudinal member of an aircraft box structure, the aircraft comprising a turbojet designed to be fixed below the lower longitudinal member and comprising a fan designed to blow an airflow from the front to the rear of the aircraft. The device comprising a thermal protection shield, designed to be arranged between the lower longitudinal member and the turbojet, comprises:
a first panel designed to extend generally parallel to a lower face of the lower longitudinal member and at a first distance from the lower face of the lower longitudinal member;
a second panel designed to be arranged between the first panel and the lower face of the lower longitudinal member, the second panel being designed to extend generally parallel to the lower face of the lower longitudinal member and at a second distance from the lower face of the lower longitudinal member.

The first and second panels delimit, relative to one another, a channel extending generally parallel and at a distance from the lower face, the channel comprising a front end designed to be located to the rear and opposite the fan of the turbojet, the front end forming an inlet orifice of a primary part of the airflow, the primary part of the airflow flowing from the front to the rear of the aircraft through the channel. The device also comprises fixing means designed to fix the thermal protection shield to the lower face of the lower longitudinal member.

In this manner, the invention proposes a rigid thermal protection of the lower longitudinal member which makes it possible to guarantee that the temperature of the shield is always optimal by causing an airflow originating from the fan to flow inside the shield. Thus, the temperature of the lower longitudinal member is effectively lowered so that it is maintained at an optimal temperature which is substantially lower than the temperature of the central zone of the turbojet which is very hot. Such a shield also makes it possible to provide a robust protection, the thickness thereof, and thus the space requirement, being optimized.

According to a first exemplary embodiment, the first and second panels are solid so that the primary part of the airflow flows solely inside the channel.

According to a second exemplary embodiment, the first panel is solid and the second panel is at least partially perforated so that the primary part of the airflow flows inside the channel and at least one secondary part of the primary part of the airflow flows through the second panel in the direction of the lower longitudinal member.

According to one particular aspect of the invention, the first panel comprises a plurality of first holes and the second panel comprises, for each first hole, a second hole coaxial to the first hole. Moreover, the thermal protection shield comprises, for each pair of an associated first hole and second hole, an insert arranged between the first and second panels, where the insert comprises a first central hole coaxial to the first hole and second hole. The first central hole, first hole and second hole permit the passage of an element of the fixing means.

According to a further particular aspect of the invention, each insert comprises a first bearing surface to which the first panel is fixed and a second bearing surface to which the second panel is fixed.

According to a further particular aspect of the invention, the second distance is greater than 2 mm, and preferably between 5 and 45 mm.

According to one particular aspect of the invention, the device comprises, for each insert, a spacer produced in a thermally resistant material, the spacer being designed to be arranged between the second panel and the lower face of the lower longitudinal member, where the spacer has a thickness generally equal to the second distance and where the spacer comprises a second central hole extending coaxially to the first hole of the associated insert and permitting the passage of the one element of the fixing means.

According to a further particular aspect of the invention, the device comprises fixing means for fixing the thermal shield to the lower longitudinal member, the fixing means comprising:
a nut support designed to be arranged against an upper face of the lower longitudinal member, the nut support comprising, for each insert, a hole coaxial to the first central hole of the insert;
for each hole, a fixing nut arranged against the nut support;
for each fixing nut, a fixing screw comprising a threaded shank designed to be successively threaded into the first central hole of the associated insert, into the second central hole of the associated spacer, into a hole of the lower longitudinal member, into the associated hole of the nut support and into the associated fixing nut to be screwed therein, and a screw head designed to come into contact with the first panel.

The invention also proposes a propulsion system comprising a turbojet designed to be fixed to a lower longitudinal member of an aircraft box structure, the system comprising a device as described above.

The invention further proposes an aircraft comprising a propulsion system as described above.

### BRIEF DESCRIPTION OF THE DRAWINGS

The above-mentioned features of the invention, and others, will appear more clearly by reading the following description of two exemplary embodiments, the description being made in relation to the accompanying drawings, in which:

FIG. 1 is a side view of an aircraft according to the invention;

FIG. 2 is a side view and sectional view of a propulsion system according to the prior art;

FIG. 3 is a side view and sectional view of a thermal cover for a propulsion system according to the prior art;

FIG. 4 is a side view and sectional view of a propulsion system according to the invention;

FIG. 5 is a perspective and sectional view of a thermal protection device for a propulsion system according to the invention;

FIG. 6a is a side view and sectional view of a thermal protection device according to a first exemplary embodiment of the invention;

FIG. 6b is a detailed view of the thermal protection device of FIG. 6a;

FIG. 7a is a side view and sectional view of a thermal protection device according to a second exemplary embodiment of the invention;

FIG. 7b is a detailed view of the thermal protection device of FIG. 7a; and

FIG. 8 is an exploded view of a thermal protection device according to the invention.

### DETAILED DESCRIPTION OF THE PREFERRED EMBODIMENTS

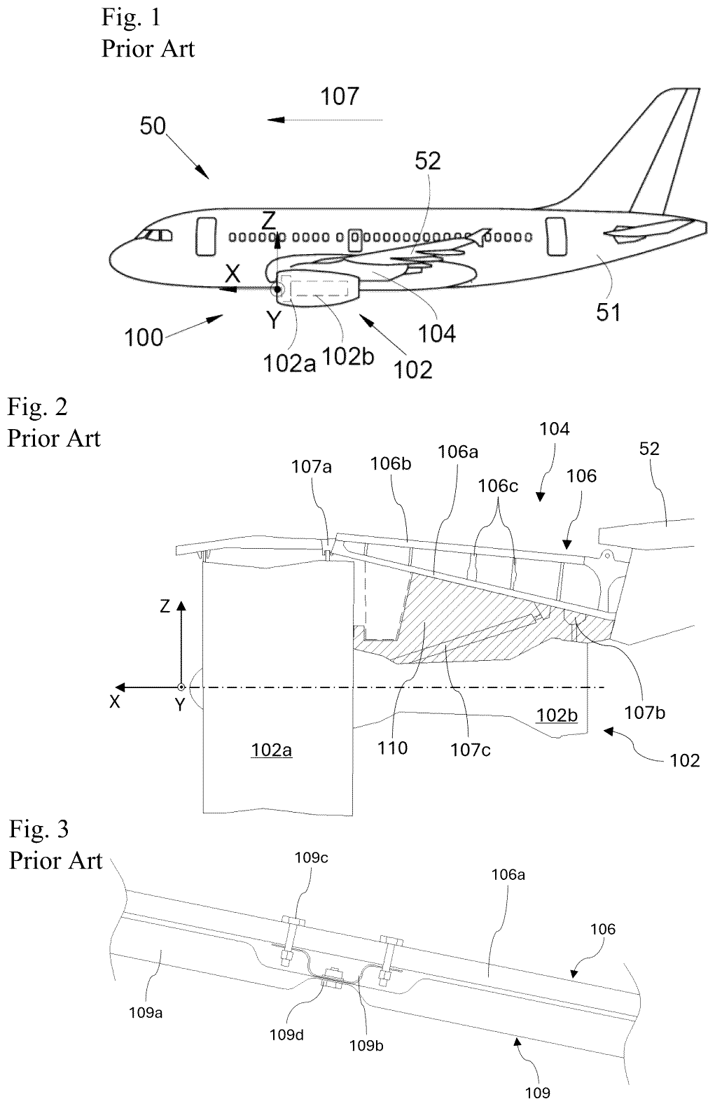

FIG. 1 illustrates an aircraft 50 according to the invention which comprises a fuselage 51 and a wing 52 on each side of the fuselage 51. At least one propulsion system 100 is fixed below each wing 52 and comprises a turbojet 102 and an engine pylon 104.

The turbojet 102 comprises, at the front, a fan housing 102a surrounding a tubular fan duct in which a fan rotates, which fan is designed to blow an airflow F (originating from the outside of the aircraft 50) from the front to the rear of the aircraft 50 and, at the rear of the fan housing 102a, a central housing 102b of smaller size enclosing the core of the turbojet 102. The fan housing 102a and the central housing 102b extend generally coaxially about the longitudinal axis X.

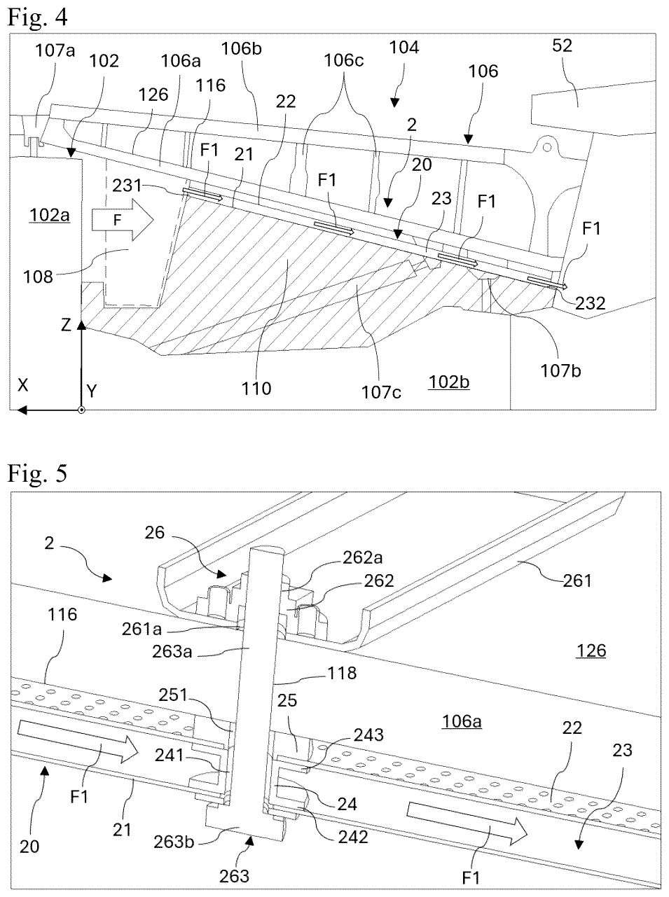

FIG. 4 shows the propulsion system 100 with the turbojet 102 and the engine pylon 104 via which the turbojet 102 is fixed to the wing 52. The engine pylon 104 is represented here by its primary structure 106 which is fixed below the wing 52.

The primary structure 106 extends along the longitudinal axis X between a front end and a rear end, and takes the form of a box structure which comprises a lower longitudinal member 106a, an upper longitudinal member 106b, two lateral panels (not illustrated) connecting the two longitudinal members and internal ribs 106c distributed along the box structure 106.

The engine pylon also comprises a secondary structure 108 which is arranged in the region of the front end of the box structure 106 and below the lower longitudinal member 106a. This secondary structure is located directly opposite the fan housing 102a and thus receives the airflow F originating from the turbojet 102.

FIGS. 4, 5, 6a and 7a illustrate examples of devices 2 designed for the thermal protection of the lower longitudinal member 106a of the box structure 106 of the aircraft 50.

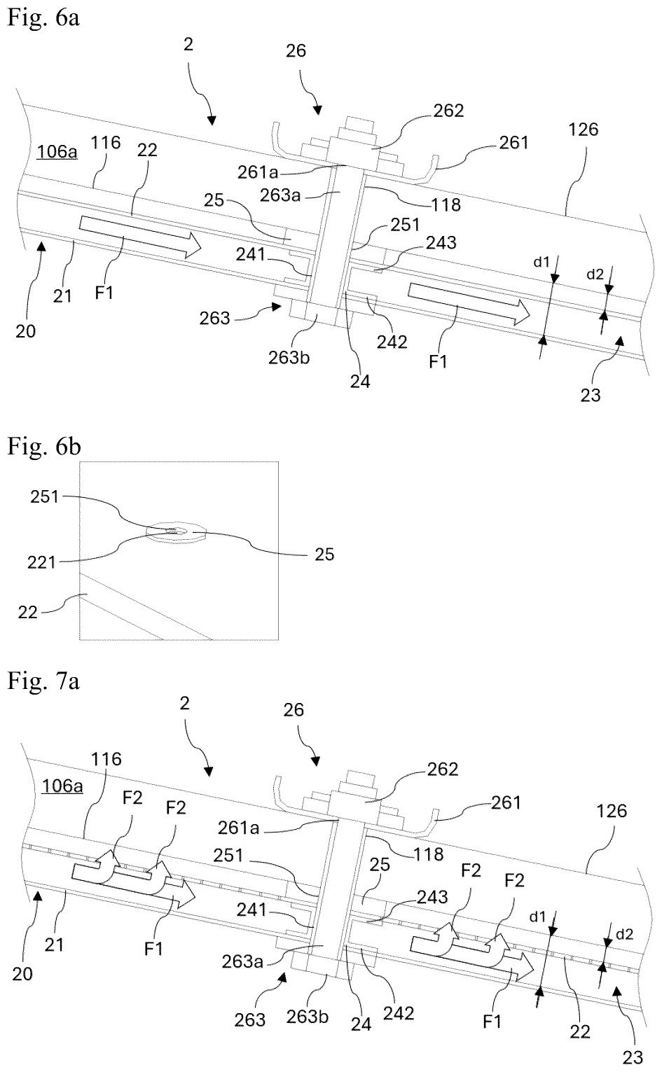

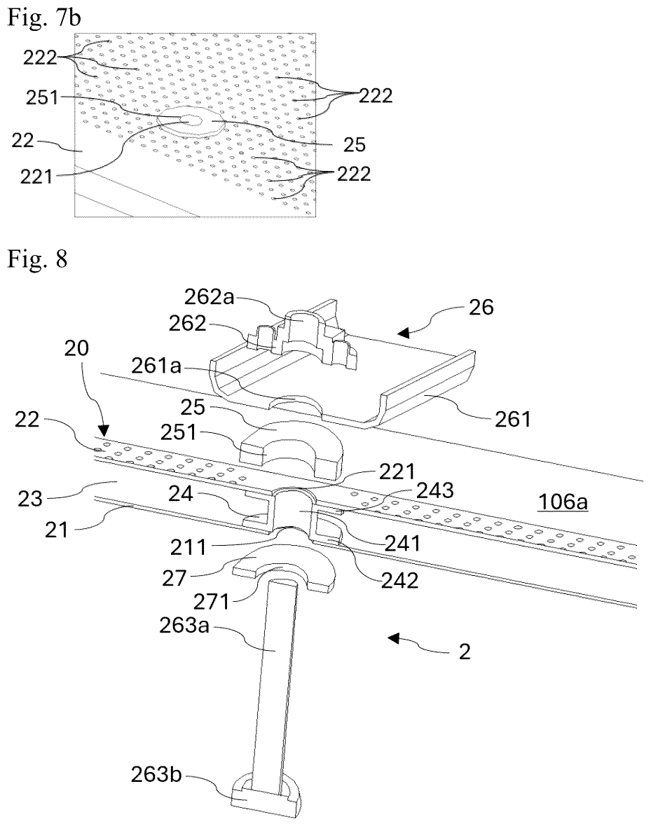

More particularly, the device 2 comprises a thermal protection shield 20 designed to be arranged between the lower longitudinal member 106a and the turbojet 102. The shield 20 comprises a first panel 21 designed to extend generally parallel to a lower face 116 of the lower longitudinal member 106a and at a first distance d1 from the lower face 116 of the lower longitudinal member 106a. For example, the first distance d1 (visible in FIGS. 6a and 7a), separating the first panel 21 from the lower face 116 of the lower longitudinal member 106a, is between 10 and 70 mm.

The thermal protection shield 20 also comprises a second panel 22 designed to be arranged between the first panel 21 and the lower face 116 of the lower longitudinal member 106a. The second panel 22 is designed to extend generally parallel to the lower face 116 of the lower longitudinal member 106a, i.e., generally parallel to the first panel 21, and at a second distance d2 from the lower face 116 of the lower longitudinal member 106a. For example, the second distance d2 (visible in FIGS. 6a and 7a), separating the second panel 22 from the lower face 116 of the lower longitudinal member 106a, is preferably between 5 and 45 mm.

Thus, it is understood that the second distance d2 is less than the first distance d1. In this manner, the first 21 and second panels 22 are separated from one another and delimit relative to one another a channel 23 which extends generally parallel and at a distance from the lower face 116 of the lower longitudinal member 106a. The thickness of the channel 23, which is obtained by subtracting the second distance d2 from the first distance d1, is between approximately 5 and 20 mm. The thickness of the channel 23 is selected as a function of the volume of air required to ventilate the thermal shield 20 (this also depends on the dimensions of the lower face 116 of the lower longitudinal member 106a, in particular).

More particularly, as shown in FIG. 4, a front, or first, end 231 of the channel 23 is designed to be located to the rear and opposite the fan of the turbojet 102 and to form an inlet orifice of a primary part F1 of the airflow F. The channel 23 comprises a second end 232 located to the rear of the propulsion system 100 which makes it possible to discharge the primary part F1 of the airflow F. The primary part F1 of the airflow F thus flows from the front to the rear of the aircraft 50 through the channel 23. The shield 20 is thus ventilated so as to lower its temperature and protect the lower longitudinal member 106a from the heat originating from the very hot central zone 110 of the propulsion system 100.

The device also comprises fixing means 26 (described in more detail in the remainder of this description) designed to fix the thermal protection shield 20 to the lower face 116 of the lower longitudinal member 106a.

Such a shield 20, which is arranged at a distance from the lower face 116 of the lower longitudinal member 106a, makes it possible, on the one hand, to provide a rigid thermal protection of the lower longitudinal member 106a and, on the other hand, to ensure that the temperature of the shield 20 is always optimal by causing an airflow originating from the fan to flow inside the shield 20. In this manner, the temperature of the lower longitudinal member 106a is effectively lowered so that it is maintained at an optimal temperature, substantially lower than the temperature of the very hot central zone 110.

Such a shield 20 also makes it possible to eliminate the use of a flexible thermal cover which is of significant thickness. In this manner, the thickness and thus the space requirement of the shield are optimized. Relative to the solutions of the prior art, the use of the shield 20 according to the invention makes it possible to release a space of at least 10 mm, for example, over the entire length of the lower longitudinal member 106a. Moreover, the materials used to produce the shield have a substantially lower cost relative to the materials used for the thermal cover of the prior art (and in particular that of the body of the cover).

A thermal protection shield 20 produced in titanium-stainless steel (for example titanium TA6V) ensures a high degree of robustness so as to limit the risks of damage during the handling and positioning of the shield 20. Moreover, this also makes it possible to limit the risks of damage caused, for example, by the installation of other equipment in the vicinity of the shield 20. Similarly, the panels 21 and 22 have a thickness between 0.2 mm and 1 mm so as to improve the robustness of the shield 20 even further.

FIGS. 6a and 6b illustrate a first exemplary embodiment of the invention in which the first 21 and second 22 panels are solid (i.e., they do not have perforations). In other words, the use of solid panels 21 and 22 permits the primary part F1 of the airflow F to flow only inside the channel 23. More specifically, the primary part F1 of the airflow F entering the channel via the first end 231 can only escape from the channel 23 through the second end 232 of the channel 23 located to the rear of the propulsion system 100. In this manner, the shield 20 acts as a cold barrier between the very hot central zone 110 of the propulsion system 100 and the lower longitudinal member 106a of the engine pylon 104. The lower longitudinal member 106a is thus protected from the heat output by the propulsion system 100.

In particular, the airflow F is supplied to the channel 23 as soon as the fan of the turbojet 102 is in operation. Air is thus continuously supplied to the channel 23 when the turbojet 102 is in operation so that the lower longitudinal member 106a is protected when the central zone 110 is hot (i.e., when the turbojet 102 is in operation).

FIGS. 5, 7a, 7b and 8 illustrate a second exemplary embodiment of the invention in which the first panel 21 is solid and the second panel 22 is at least partially perforated. In other words, the primary part F1 of the airflow F can circulate in the channel 23 from the first end 231 as far as the second end 232 but at least one secondary part F2 of the primary part F1 of the airflow F can flow through the second panel 22 which is at least partially perforated so that this secondary part F2 can flow in the direction of the lower longitudinal member 106a and cool it directly.

In this manner, the shield 20 acts as a cold barrier between the very hot central zone 110 of the propulsion system 100 and the lower longitudinal member 106a of the engine pylon 104, while permitting a continuous and direct ventilation of the lower face 116 of the lower longitudinal member 106a, so as to protect in an optimal manner the lower longitudinal member 106a from the heat of the central zone 110.

In particular, the airflow F is supplied to the channel 23 as soon as the fan of the turbojet 102 is in operation. Air is thus continuously supplied to the channel 23 when the turbojet 102 is in operation so that the lower longitudinal member 106a is protected from the heat and ventilated by the air when the central zone 110 is hot (i.e., when the turbojet 102 is in operation).

The second panel 22 has perforations which are preferably distributed in a generally uniform manner. As a function of the ventilation requirements of the shield 20, the perforations can have a diameter of approximately 1 mm and be spaced apart by 3.5 mm or even have a diameter of 2.5 mm and be spaced apart by 6 mm, for example. In this manner, the secondary part F2 represents an optimal flow to ensure an optimal protection and ventilation of the lower longitudinal member 106a.

According to the two exemplary embodiments described above, and as illustrated in FIGS. 5 to 8, the first 21 and second 22 panels respectively comprise a plurality of first 211 and second 221 perforations which extend generally coaxially therebetween. In other words, the first panel 21 comprises a plurality of first holes 211 and the second panel 22 comprises, for each first hole 211, a second hole 221 coaxial to the first hole 211. Moreover, the thermal protection shield 20 comprises, for each pair of an associated first hole 211 and second hole 221, an insert 24 which is arranged between the first 21 and second 22 panels. More particularly, each insert 24 comprises a first central hole 241 which extends coaxially to an associated first hole 211 of the first panel 21 and a second hole 221 of the second panel 22. The first central hole 241, first hole 211 and second hole 221 permit the passage of an element of the fixing means 26 (described below).

In particular, each insert 24 comprises a first bearing surface 242, of substantially circular shape in this example, to which the first panel 21 is fixed and a second bearing surface 243, also of substantially circular shape in this example, to which the second panel 22 is fixed. The first 242 and second 243 bearing surfaces extend generally parallel and are located opposite one another. The first 242 and second 243 bearing surfaces extend generally in the region of the ends of the central hole 241.

As illustrated in FIGS. 5 to 8, the panels 21 and 22 are fixed to the external faces of the bearing surfaces 242 and 243. In other words, the inserts 24 are encompassed/clamped between the panels 21 and 22.

It is possible to select the thickness of the insert 24 (i.e., the distance separating the first 242 and second 243 bearing surfaces) as a function of the desired thickness of the channel 23 to provide thermal protection to the lower longitudinal member 106a in an optimal manner. Preferably, the thickness of the insert 24 is between 5 and 20 mm.

For example, the panels 21 and 22 are welded, or soldered, to the inserts 24. However, other fixing techniques can be envisaged without departing from the principle of the invention.

These inserts make it possible to reinforce/stiffen the shield 20 and, as detailed in the remainder of this description, to fix the shield 20 to the lower longitudinal member 106a.

It is thus easily understood that it is conceivable to use as many inserts 24 as required in order to ensure, on the one hand, an optimal fixing of the shield 20 to the lower longitudinal member 106a and, on the other hand, a good structural behavior of the shield 20.

Moreover, inserts 24 can be used solely to reinforce the structure of the shield 20. In this case, these reinforcing inserts 24 do not cooperate with the fixing means 26 (described below).

Preferably, the second distance d2 separating the second panel 22 from the lower face 116 of the lower longitudinal member 106a is approximately between 5 and 45 mm.

According to the two exemplary embodiments described above, and as illustrated, the device 2 comprises, for each insert 24, a spacer 25 produced in a thermally resistant material (i.e., a material capable of resisting the specific environment of the invention in which the temperatures can reach 500° C., for example). Preferably the spacer 25 is produced in ceramic material. More specifically, such a material has a conductivity of 0.01 J/s/cm2 (° C./cm) which in certain cases enables it to withstand temperatures able to go up to 1260° C., for example. The spacer 25 is designed to be arranged between the second panel 22 and the lower face 116 of the lower longitudinal member 106a. The spacer 25 has a thickness generally equal to the second distance d2 and enables a thermal insulation and a uniform spacing to be guaranteed between the lower face 116 of the lower longitudinal member 106a and the shield 20. The spacer 25 also makes it possible to optimize the role of a thermal barrier played by the shield 20.

As above, the spacer 25 comprises a second central hole 251 extending coaxially to the first hole 241 of the associated insert 24 and permitting the passage of the element of the fixing means 26 of the thermal protection shield 20 to the lower longitudinal member 106a (as detailed in the remainder of this description). The spacer 25 thus has a thickness (generally equal to the second distance d2) which is selected in order to avoid any risk of crushing the shield 20 when the fixing means 26 are clamped.

The thickness of the spacer 25 can thus be varied as a function of the installations.

Moreover, the spacer 25 makes it possible to limit the thermal bridges between the shield 20 and the lower face 116 of the lower longitudinal member 106a. It also enables a mounting clearance to be provided between the shield 20 and the lower longitudinal member 106a in order to take into account the fishplate fixings of the engine pylon 104 (i.e., the fixings between the longitudinal members and the lateral panels and/or the ribs, in particular).

As discussed above, the device 2 comprises fixing means 26 for fixing the thermal shield 20 to the lower longitudinal member 106a. These fixing means 26 comprise a nut support 261 designed to be arranged against an upper face 126 (i.e., the face opposing the lower face 116) of the lower longitudinal member 106a. The nut support 261 comprises, for each insert 24, a hole 261a which extends coaxially to the first central hole 241 of the corresponding insert 24 (and thus also coaxially to the associated holes 211 and 221 of the first and second panels 21 and 22).

The fixing means 26 comprise, for each hole 261a, a fixing nut 262 arranged against the nut support 261 on the face of the nut support 261 opposing the lower longitudinal member 106a. The fixing nut 262 comprises a threaded hole 262a which extends coaxially to the first central hole 241 of the associated insert 24 (and thus also coaxially to the associated holes 211 and 221 of the first and second panels 21 and 22 and the associated hole 261a of the nut support 261).

The fixing means 26 also comprise, for each fixing nut 262, a fixing screw 263 which comprises a threaded shank 263a designed to be threaded successively into the first central hole 241 of the associated insert 24, into the second central hole 251 of the associated spacer 25, into a hole 118 of the lower longitudinal member 106a, into the associated hole 261a of the nut support 261 and into the threaded hole 262a of the associated fixing nut 262 in order to be screwed therein. The fixing screw 263 also comprises a screw head 263b designed to come into contact with the first panel 21 so that the screw head 263b and the fixing nut 262 clamp the shield 20 and the lower longitudinal member 106a.

Such fixing means enable a reliable assembly of the shield 20 to the lower longitudinal member 106a to be ensured. Moreover, the manner in which the shield 20 is fixed to the lower longitudinal member 106a makes it possible to limit, or even eliminate, the thermal bridges in the region of the different fixing points of the shield 20 to the lower longitudinal member 106a.

Moreover, such fixing means 26 are simple and inexpensive to use.

Preferably, the fixing means 26 also comprise a washer 27 comprising a third central hole 271. The washer 27 is arranged between the screw head 263b and the first panel 21 and the threaded shank 263a is designed to be threaded into the third central hole 271.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device configured to thermally protect a lower longitudinal member of a box structure of an aircraft, said aircraft comprising a turbojet configured to be fixed below said lower longitudinal member and comprising a fan configured to blow an airflow from the front to the rear of said aircraft, said device comprising a thermal protection shield configured to be arranged between said lower longitudinal member and said turbojet, which comprises:
a first panel configured to extend generally parallel to a lower face of said lower longitudinal member and at a first distance from said lower face of said lower longitudinal member;
a second panel configured to be arranged between said first panel and said lower face of said lower longitudinal member, said second panel being configured to extend generally parallel to said lower face of said lower longitudinal member and at a second distance from said lower face of said lower longitudinal member;
wherein said first and second panels delimit, relative to one another, a channel comprising a front end configured to be located to the rear and opposite said fan of said turbojet, said front end forming an inlet orifice of a primary part of said airflow, said primary part of said airflow flowing from the front to the rear of said aircraft through said channel; and
a fixing arrangement configured to fix said thermal protection shield to said lower face of said lower longitudinal member,
wherein said first panel is solid and said second panel is at least partially perforated so that said primary part of said airflow flows inside said channel and at least one secondary part of said primary part of said airflow flows through said second panel in a direction of said lower longitudinal member.

2. The device according to claim 1,
wherein said first panel comprises a plurality of first holes,
wherein said second panel comprises, for each first hole, a second hole coaxial to said first hole, and
wherein said thermal protection shield comprises, for each pair of an associated first hole and a second hole, an insert arranged between said first and second panels, wherein the insert comprises a first central hole coaxial to said first hole and second hole, and wherein said first central hole, first hole and second hole permit the passage of an element of said fixing arrangement.

3. The device according to claim 2, wherein each insert comprises a first bearing surface to which the first panel is fixed and a second bearing surface to which the second panel is fixed.

4. The device according to claim 1, wherein said second distance is between 5 and 45 mm.

5. The device according to claim 2,
wherein the device comprises, for each insert, a spacer configured to be arranged between said second panel and said lower face of said lower longitudinal member,
wherein said spacer has a thickness generally equal to said second distance, and
wherein said spacer comprises a second central hole extending coaxially to said first hole of the associated insert and permitting a passage of said one element of said fixing arrangement.

6. The device according to claim 5, wherein said fixing arrangement comprises:
a nut support configured to be arranged against an upper face of said lower longitudinal member, said nut support comprising, for each insert, a hole coaxial to said first central hole of said insert;
for each hole, a fixing nut arranged against said nut support,
for each fixing nut, a fixing screw comprising a threaded shank configured to be successively threaded into said first central hole of the associated insert, into said second central hole of the associated spacer, into a hole of said lower longitudinal member, into said associated hole of said nut support and into said associated fixing nut in order to be screwed therein, and a screw head configured to come into contact with said first panel.

7. A propulsion system comprising a turbojet configured to be fixed to a lower longitudinal member of an aircraft box structure, said propulsion system comprising a device according to claim 1.

8. An aircraft comprising a propulsion system according to claim 7.
